(19) United States
(12) Patent Application Publication
(10) Pub. No.: US 2003/0187822 A1
(43) Pub. Date: Oct. 2, 2003

(54) Multiple image file system

(75) Inventors: Charles R. Lefurgy, Round Rock, TX (US); Eric Van Hensbergen, Austin, TX (US)

Correspondence Address: Joseph P. Lally, DEWAN & LALLY, L.L.P., P.O. Box 684749, Austin, TX, 78768-4749, US

(73) Assignee: International Business Machines Corporation, Armonk, NY

(21) Appl. No.: 10/112,497

(22) Filed: Mar. 28, 2002

(51) Int. Cl. G06F 7/00

(52) U.S. Cl. 707/1

(57) ABSTRACT

A file system and method for maintaining multiple images of a data file and providing the appropriate image to an application in a manner that is substantially transparent to the user. The system would typically comprise a file system portion of a computer operating system. The file system is mounted at an appropriate mount point, such as a directory under the root file system. The file system provides two or more views of a file that contains data. The file system may present the different hierarchy views as different directory paths. The file system further allows different applications to access the file via different directory paths. Depending upon the directory path via which an application accesses the file, the file system may modify the format of the data provided to the application. In one embodiment, the file is stored in a compressed data format. When the file is accessed with an application requiring un-compressed data, the file system invokes a filter that converts the compressed to an un-compressed formation before providing the data to the application. Other embodiments may emphasize other attributes, characteristics, or formats of the data file including, as example, encryption formatting, and language characteristics. The file system may store the file as a single physical image or in multiple images depending upon the implementation.

### BACKGROUND

1. Field of the Present Invention

The present invention generally relates to field of data processing systems and more particularly to a data processing system incorporating a file system providing two or more images of a file to facilitate transparent use of the file for different purposes.

2. History of Related Art

In the field of data processing systems, files and other data objects may be stored in various formats to achieve a desired result. For purposes of this disclosure, a data format refers to the manner in which data is stored (as opposed to the content of the data). Data compression, as an example, facilitates data storage by reducing the amount of available storage space required to contain a file. Files may be stored in a compressed format to save storage space and later converted to an un-compressed format for viewing, editing, printing, and the like.

Conventional web servers are now able to send compressed data, such as on-the-fly compressed Hypertext Markup Language (HTML) documents and conventional browsers are configured to read a Multipurpose Internet Mail Extension (MIME) tag in the Hypertext Transport Protocol (HTTP) header of the file. If the MIME tag indicates that the file is compressed, the browser will typically un-compress the file on-the-fly before the file is parsed. This optimization saves in the transfer time of the file as well as in storage space, in both memory and disk, required of the server and any intermediate cache proxies. Unfortunately, anecdotal evidence suggests that use of this features is almost nonexistent because it is difficult to maintain HTML pages as compressed files. Each time a web page that is stored in a compressed format requires editing, a preliminary step of un-compressing the file must be performed. Thus, every editing cycle would require the editor to un-compress the file using a compression utility, store the un-compressed file, edit it, save it back to disk, compress the file, and (if available disk space is a concern) delete the un-compressed version. With many HTML pages requiring frequent or regular maintenance, the administrative overhead imposed by maintaining the source pages in a compressed format tends to prevent wide-spread use of the feature.

Data compression provides just one example of the various formats in which a data file may be stored. Data files may also occur in encrypted and unencrypted formats. In the case of an encrypted format, a file may be encrypted according to one of a variety of known encryption algorithms. An encrypted format generally provides beneficial security features when the file is transferred between two systems, especially over an un-secure network such as the Internet. Like compressed data, however, an encrypted file must generally be unencrypted before it can be viewed, edited, or otherwise “used.”

In another example, it may be desirable to provide a document in various languages such as English and Spanish. It may be undesirable, however, to maintain separate copies of the document in each language because of storage limitations and coherency issues. It may be equally undesirable or difficult to store the document in one language and require the user to translate the document manually (such as by invoking a translator utility) each time modifications are to be made to the document.

As each of the described examples illustrates, it would be desirable to implement a system and method for storing documents in such a way that, depending upon the application that requests the document, different formatting attributes of the stored document are invoked. It would be further desirable if the implemented solution required no modification to existing applications such as web servers, web editors, or other applications that work with data. It would be still further desirable if the implemented solution was substantially transparent to the system user.

### SUMMARY OF THE INVENTION

The problems identified above are in large part addressed by a system and method for maintaining multiple images of a data file and providing the appropriate image to an application in a manner that is substantially transparent to the user. The system would typically comprise a file system portion of a computer operating system. The file system is mounted at an appropriate mount point, such as a directory under the root file system. The file system provides two or more views of a file that contains data. The file system may present the different views as different directory paths and allows different applications to access the file via the different directory paths. Depending upon the directory path used by an application to access a file, the file system may modify the format of the data before providing the data to the application. In one embodiment, the file is stored in a compressed data format. When the file is accessed with an application requiring un-compressed data, the file system invokes code referred to herein as a filter that converts the compressed to an un-compressed formation before providing the data to the application. Other embodiments may emphasize other attributes, characteristics, or formats of the data file including, as examples, encryption formatting, and language characteristics. The file system may store the file as a single physical image or in multiple images depending upon the implementation.

### BRIEF DESCRIPTION OF THE DRAWINGS

Other objects and advantages of the invention will become apparent upon reading the following detailed description and upon reference to the accompanying drawings in which:

FIG. 1 is a block diagram of selected features of a data processing system suitable for use in one embodiment of the invention;

FIG. 2 is a block diagram of selected features of a data processing network suitable for use in one embodiment of the invention;

FIG. 3 is a conceptual representation of selected software elements in a computer readable medium such as the system memory of a data processing system according to one embodiment of the invention; and

FIG. 4 is a representation of a multiple image file system according to one embodiment of the invention wherein the manner in which a file is specified via the file system affects the content of the data that is retrieved or stored.

While the invention is susceptible to various modifications and alternative forms, specific embodiments thereof are shown by way of example in the drawings and will herein be described in detail. It should be understood, however, that the drawings and detailed description presented herein are not intended to limit the invention to the particular embodiment disclosed, but on the contrary, the intention is to cover all modifications, equivalents, and alternatives falling within the spirit and scope of the present invention as defined by the appended claims.

### DETAILED DESCRIPTION OF THE INVENTION

Generally speaking, the present invention contemplates a system and method that includes a file system that exposes multiple representations or images of file data. When a first application accesses the file, a first image of the data is provided to the application while a second image of the data is provided to a second application that accesses the data. Additional representations may be provided depending upon the implementation. The invention may be implemented as a file system that achieves the multiple representation by presenting two views of the file hierarchy to the user. In this embodiment, the file image presented may be dependent upon the directory path that is mounted to access the file. Accessing the file via a first directory tree, for example, retrieves the first image of the file while accessing the file via a second directory tree retrieves a second image of the file.

In this manner, multiple formats may be associated with a data file in a manner that is substantially transparent to the user. A data file may be stored, for example, in a compressed format on disk. When a user attempts to access the file with a particular application such as an editor, the file system transparently provides an un-compressed image of the file to the user. After the user is finished editing, the file may be saved back to disk in the compressed format to conserve storage resources.

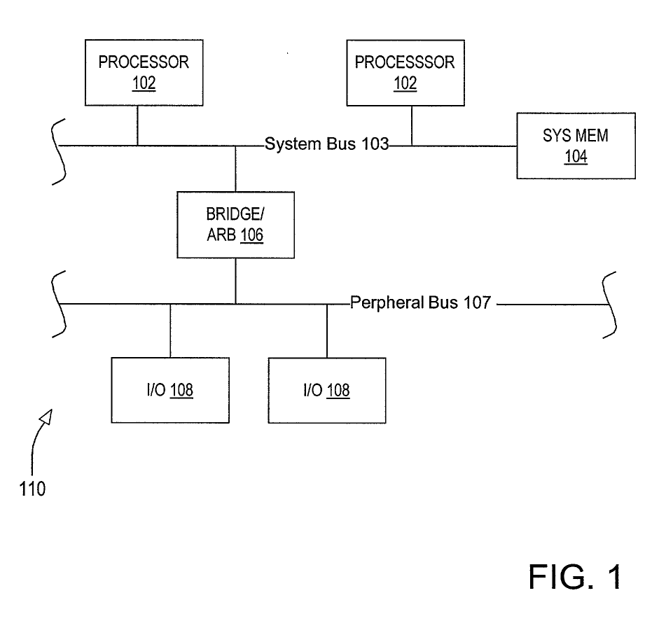

Referring now to FIG. 1, a data processing system 110 suitable for use with an embodiment of the invention is depicted. Data processing system 110 includes one or more processors 102, each connected to a system bus 103. Processors 102 may be implemented with any of various commercially distributed general purpose microprocessors including PowerPC® processors from IBM Corporation and ×86 compatible processors such as the Pentium® family of processors from Intel Corporation. Processors 102 as depicted access a volatile system memory 104 via the system bus 103. In addition, a bus bridge/bus arbiter 106 is connected between the system bus 103 and a peripheral bus 107 such as a PCI bus. One or more peripheral device(s) or adapter(s) 108 are connected to the peripheral bus 107. Peripheral devices 108 may include any number of devices including, as examples, hard disk adapters, graphics adapters, audio adapters, and high-speed network adapters.

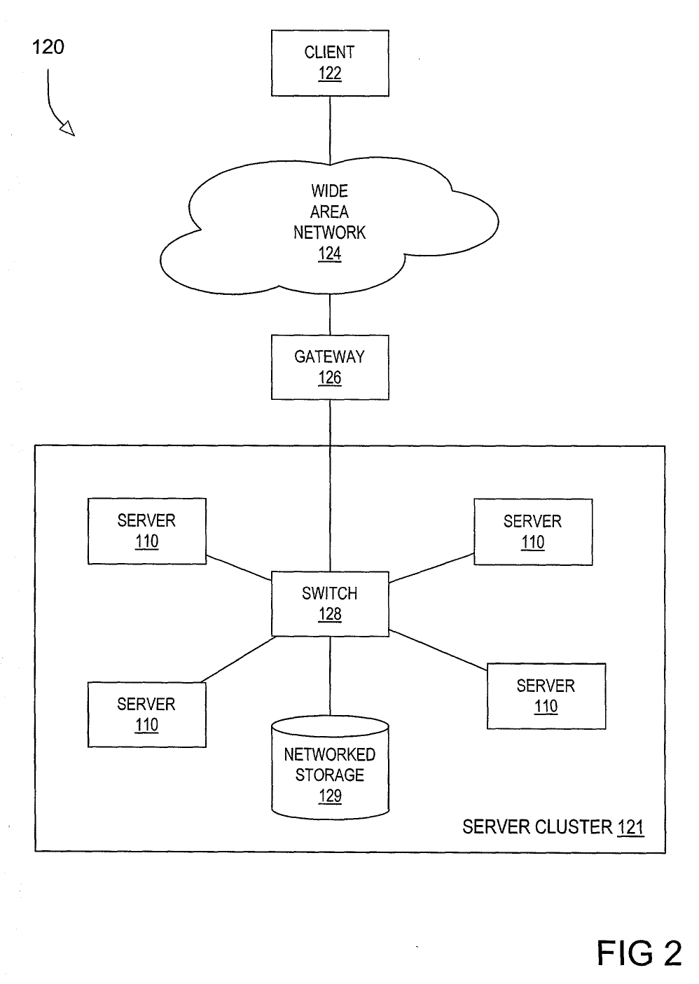

In one implementation data processing system 110 may comprise a server in a data processing network. Turning now to FIG. 2, selected features of a data processing network 120 suitable for use with one embodiment of the invention are depicted. In the depicted embodiment, network 120 includes a client 122 connected to a wide area network 124. Client 122 typically includes a client application program such as a conventional web browser that is executing on a client device. The client device may comprise a desktop or laptop personal computer, a network computer or workstation, or another network aware device such as a personal digital assistant (PDA) or an Internet enabled phone. Although client 122 is illustrated as connected to server network 121 through the intervening WAN 124, other clients (not depicted in FIG. 1) may be connected to the server network itself.

Wide area network 124 typically includes various network devices such as gateways, routers, hub, and one or more local area networks (LANs) that are interconnected with various media possibly including copper wire, coaxial cables, fiber optic cables, and wireless media. Wide area network 124 may represent or include portions of the Internet.

In the depicted embodiment, a server network or server cluster 121 is connected to client 122 through a gateway 126 connected to wide area network 124. Server cluster 121 is typically implemented as a LAN that includes one or more servers 110 (four of which are shown). The servers 110 may be networked together over a shared medium such as in a typical Ethernet or Token ring configuration. Servers 110 have access to a persistent (non-volatile) storage medium such as a magnetic hard disk. Any server 110 may include its own internal disk and disk drive facilities. In an increasingly prevalent configuration, persistent storage is provided as a networked device or set of devices. Networked storage is identified in FIG. 1 by reference numeral 129 and may be implemented as one or more network attached storage (NAS) devices, a storage area network (SAN) or a combination thereof.

Portions of the invention may be implemented as a sequence of computer executable instructions (software) stored on a computer readable medium for implementing multiple images of a data file in a data processing system. When the software is being executed, the software (or portions thereof) are stored on a volatile medium such as the system memory (DRAM) of the data processing device or a cache memory (SRAM) of its general purpose microprocessor. At other times, the software may reside on a non-volatile medium such as a hard disk, floppy diskette, CD ROM, DVD, flash memory card or other electrically erasable device, a magnetic tape, and so forth.

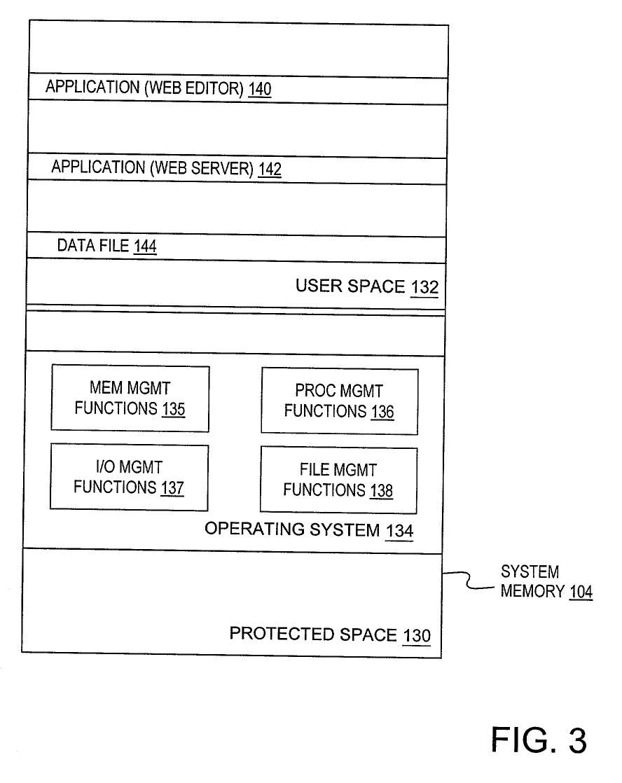

Referring now to FIG. 3, a conceptual representation of selected software modules loaded in the system memory 104 of a data processing device such as one of the servers 110 depicted in FIG. 2 according to one embodiment of the invention is depicted. In the depicted embodiment, system memory 104 is broadly divided into two major partitions, namely, a user space 132 and a protected space 130. As their names imply user space 132 is dedicated to applications and data that are generally accessible to users of the system while protected space 130 includes software modules, including an operating system 134 and other trusted code, to which access is restricted.

The depicted embodiment illustrates a user space 132 that currently contains at least portions of a first application 140 identified as a web editor and a second application 142 identified as a web server. The specification of a web editor and web server are intended as specific examples of applications that might benefit from multiple images of a data object. Other implementations are not intended to be limited to these particular applications. In addition to applications 140 and 142, user space 132 as depicted includes at least a portion of a data file 144. Data file 144 may be created by one of the applications 140 or 142 and typically contains information used or modified by the application programs.

The protected space 130 depicted in FIG. 3 includes an operating system 134. Generally speaking, operating system 134 represents software that manages the resources of data processing system 110. Operating system 134 includes memory management functions 135, processor management functions 136, I/O management functions 137, and file management functions (file system) 138. Memory management functions 135 are generally responsible for allocating memory resources to the various processes and deallocating memory when processes terminate. Processor management functions 136 control which processes are allowed to access processor resources. I/O management functions 137 perform I/O scheduling and allocation of I/O devices. File system 138 manages the organization, allocation, and accessing of a system's file records. Operating system 134 may include portions or characteristics of commercially distributed operating systems including Unix-derivative operating systems such as the AIX® operating system from IBM Corporation, Linux® operating systems, and the Windows® family operating systems from Microsoft.

The present invention is primarily concerned with file system 138. In a conventional file system, there is a one-to-one correspondence between a filly specified directory path and file name combination. While symbolic references and path names may be used to create, for example, a “shortcut” to a particular file, the underlying path/filename uniquely specifies an image on a storage medium. Worded alternatively, it may be said of conventional file systems generally that the pathname and filename combination are solely indicative of the physical location of a file. While filename extensions may communicate information about the format of a file's content, the file system is generally indifferent to file extensions except to the extent that they form a unique filename. Thus, for example, a file system would translate two filenames that differ only in their extensions into two different physical locations.

Generally speaking, the invention contemplates a file system having a layer that exposes multiple views of a file depending upon the manner in which (or the application from which) a file is accessed. Using this “filtering” layer, the file system according to the present invention is configured to provide a view or image of a data file that is most suitable for the application. The file system preferably achieves this filtering transparently to the user. In this manner, the file system provides this multiple view functionality without requiring modification of existing applications.

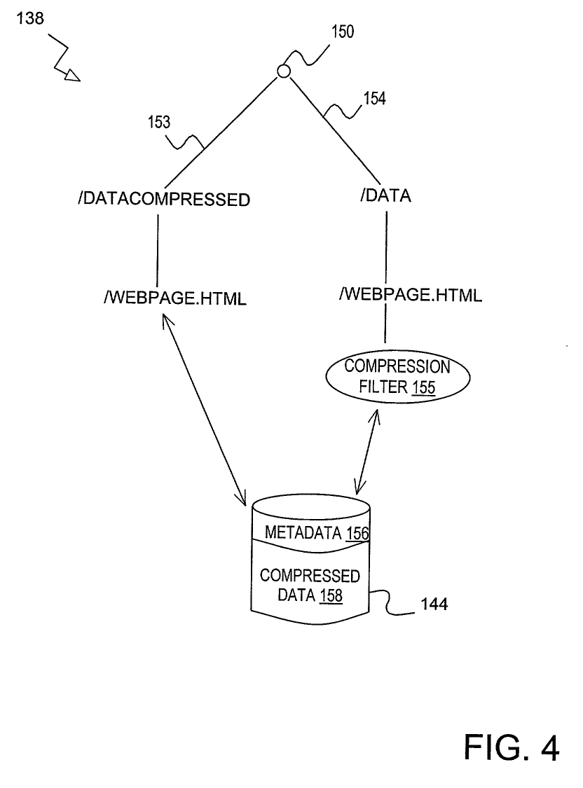

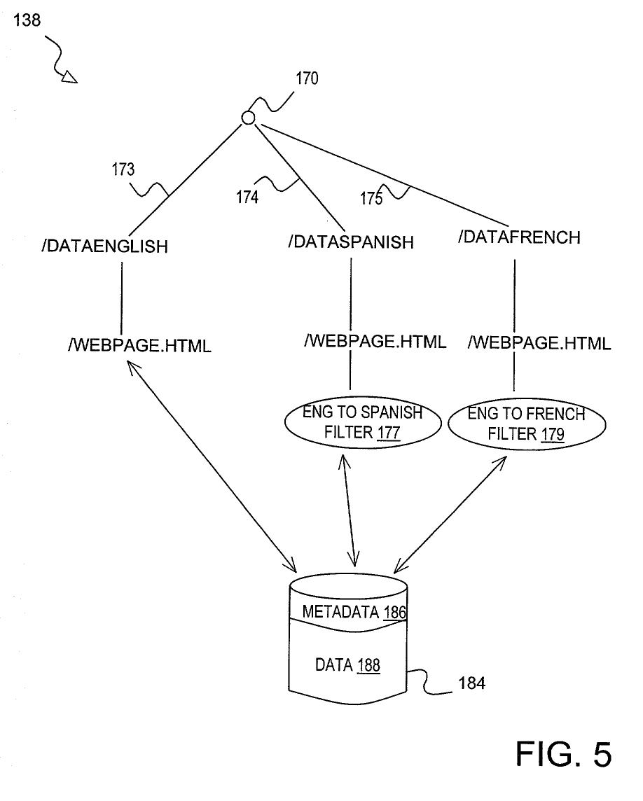

Referring to FIG. 4, a conceptual representation of selected portions of a file system 138 according to one embodiment of the present invention is depicted. In the depicted embodiment, file system 138 includes a mount point 150 and at least two directory paths 153 and 154. In a Unix-based operating system, file system 138 may be associated with a directory, referred to as the mount point, within a currently mounted file system (where “mounting a file system” refers to the process of making the file system available for access).

In file system 138, a single data file may be accessed via two (or more) unique directory paths. Moreover, the user is presented with a view of the requested file that depends upon the directory path selected. In the depicted embodiment, for example, a file identified by reference numeral 144 is accessible via two unique directory paths 153 and 154. Data file 144 includes a data portion 158 and a metadata portion 156. For purposes of this disclosure, metadata 156 identifies characteristics, formatting, or other attributes of data portion 158. In this sense, metadata is commonly described as “data about data.” In the illustrated example, the data portion 158 of data file 144 is stored in a compressed format. Data compression formats are well known in the field of data processing systems. Data compression is typically used to reduce the size of large data files. Smaller data files consume less bandwidth when transferred across a network such as the Internet and require less server storage.

In one embodiment of widespread applicability, data file 144 represents a document written in the Hypertext Markup Language (HTML). HTML is a markup language in an extremely large number of web pages are written. Some web pages are of substantial size (i.e., in excess of 1 MB). Although high speed Internet connections are becoming increasingly common, many users still experience frustratingly long delays when retrieving large documents over the Internet. Generally speaking, most web servers are capable of sending web pages in compressed format and most client-side web browsers are capable of un-compressing the data as it is received. Sadly, exceedingly few web pages are maintained and sent across the Internet in compressed format because of the additional overhead required to edit or otherwise update a web page that is stored in compressed format.

File system 138 according to one embodiment of the present invention addresses this unfortunate reality by providing a transparent mechanism that enables the web page to be stored and transmitted in a compressed format without imposing an additional burden on applications that are designed to modify the web page. File system 138 incorporate a filtering layer that manipulates the contents of a file depending upon the manner in which the file is retrieved. In FIG. 4, for example, a first directory path /DATACOMPRESSED 153 is used by applications, such as a web server, that are configured to access the compressed data 158 in data file 144 directly. A second directory path /DATA 154 is used by applications, such as a web page editor, that require an un-compressed version of the data file 144.

In this embodiment, file system 138 is configured to invoke an un-compression filter 155 when data file 144 is opened or otherwise accessed via directory path 154. Filter 155 represents binary (executable) code that converts compressed data 158 to an un-compressed format. In one embodiment, the code representing filter 155 is proprietary code embedded within file system 158. Alternatively, filter 155 may comprise an existing or legacy compression/un-compression utility that is called by file system 138 when directory path 154 (analogous to the manner in which a web browser invokes a plug in).

Using file system 138, a single physical image of file 144 is typically stored on disk to conserve disk space. As depicted in FIG. 4, the image is stored in the format that consumes the least space although this is not strictly required by the invention. File 144 could, for example, contain an un-compressed version of the data. In this implementation, a compression filter (not depicted) would be invoked when an application requiring (or capable of using) compressed data accesses the file via directory path 153 while applications requiring un-compressed data would be able to access the data directly (i.e., without invoking a file system filter) via directory path 154. Extending the multiple image concept further, file 144 could be stored in a format that is not optimal for either of two (or more) applications that access it. In this embodiment, directory paths 153 and 154 may both invoke filters to convert the stored image of the data to an image compatible with the requesting application.

Although the embodiment illustrated in FIG. 4 emphasizes compressed and uncompressed formats as the views or images of the underlying data exposed by file system 138, the multiple image file system according to the present invention is extensible to essentially any instance in which data may exist in alternative formats. As an example, file system 138 may expose encrypted an unencrypted images of a data file. In one implementation, the file is stored on disk (or other storage medium) in an encrypted format. Returning to the example of a web page, conventional web servers are typically enabled to transmit encrypted web pages and client side web browsers are enabled to decrypt encrypted data on-the-fly. The web editor, however, will typically operate only on un-encrypted data. In this case, filed system 138 may include directory paths /DATAENCRYPTED and /DATA, where each directory contains a link to the physically stored data file. When the encrypted data file is accessed through the /DATAENCRYPTED directory, no filtering is required by file system 138. When the data file is accessed by the web editor or other application needing decrypted data, the file system invokes a decryption algorithm before presenting the data to the requesting application.

The implementations described thus far store just a single physical image of a data file thereby beneficially conserving scarce storage resources. In other implementations, however, file system 138 may be configured to maintain physical images of each view that the system is capable of exposing. Returning to the compression/un-compression implementation, for example, one embodiment of file system 138 may maintain two physical files, a compressed image and an un-compressed image. In this instance, file system 138 is configured to maintain coherency between the two images. Thus, if modifications are made to a first image (whether the first image is the compressed or un-compressed image) of the file, file system 138 would invoke the appropriate filter to generate a second image of the file that is coherent with the modified first image. This implementation might prove beneficial in an implementation of file system 138 that exposes data files in different languages. As an example, an English image and a Spanish image of a file may be maintained by file system 138 using direction paths such as \DATAENGLISH and \DATASPANISH. When a user modifies the English image of the file, file system 138 invokes a translator filter that converts the modified English version of the file to a coherent Spanish version of the file. Similarly, if a Spanish speaking user modifies the Spanish image, file system 138 updates the English image with an appropriate Spanish-to-English translator filter.

Turning now to FIG. 5, an embodiment of the language translation implementation is illustrated to illustrate the use of multiple filters. In the depicted implementation, file system 138 includes a mount point 170 from which multiple directory paths 173, 174, and 175 extend. In this implementation, a file 184 includes textual data 188 and metadata 186. Textual data 188 may be stored in any language. In the illustrated example, it is assumed that textual data 188 is written in English. Data file 184 is accessible with file system 138 via a set of directory paths, three of which are shown. If data file 184 is accessed via the directory path /DATAENGLISH (reference numeral 173), the data is provided directly to the user without translation. If, on the other hand, data file 184 is accessed via the directory path /DATASPANISH (174) or /DATAFRENCH (175), file system 183 invokes filters in the form of language translators 177 and 179 respectively to provide the requesting application with a version of the requested text translated to the appropriate language. This example illustrates the ability of file system 183 to implement more than two directory paths using multiple filters.

It will be apparent to those skilled in the art having the benefit of this disclosure that the present invention contemplates a file system enabled to expose multiple views or images of a data file in a manner transparent to the user. It is understood that the form of the invention shown and described in the detailed description and the drawings are to be taken merely as presently preferred examples. It is intended that the following claims be interpreted broadly to embrace all the variations of the preferred embodiments disclosed

What is claimed is:

1. A data processing system including at least one processor, a system memory accessible to the processor, and I/O means, the system memory containing at least portions of an operating system including a multiple image file system, comprising:
file system code means for providing first and second views of a file containing data;
file system code means enabling first and second applications to access the file via the first and second views respectively; and
file system code means for modifying the format of the data depending upon which view was used to access the file.

2. The system of claim 1, wherein the first and second views are implemented as first and second directory paths.

3. The system of claim 1, wherein the first and second views of the data correspond to a compressed format and an un-compressed format respectively of the data file.

4. The system of claim 3, wherein the data file is stored in an compressed format.

5. The system of claim 4, wherein the first application is a web editor requiring the un-compressed format and the second application is a web server capable of using the compressed format of the data file.

6. The system of claim 1, wherein the first and second views of the data correspond to an encrypted and an unencrypted format respectively of the data file.

7. The system of claim 1, wherein the data file contains text data and wherein each view corresponds to a language such that accessing the file via the first view retrieves the text data in a first language and accessing the file via the second view retrieves the text data in a second language.

8. The system of claim 1, wherein the code means for modifying the data format includes a first filter that is invoked when the file is accessed via the first view.

9. The system of claim 8, wherein the code means for modifying the data format further includes a second filter that is invoked when the file is access via the second view.

10. The system of claim 8, wherein the file is stored in a format compatible with the second application such that accessing the file via the second view requires no format modification.

11. A computer program product comprising a computer readable medium configured with computer executable instructions for providing a file system, the product comprising:
file system code means for providing first and second views of a file containing data;
file system code means enabling first and second applications to access the file via the first and second views respectively; and
file system code means for modifying the format of the data depending upon which view was used to access the file.

12. The computer program product of claim 11, wherein the first and second views are implemented as first and second directory paths.

13. The computer program product of claim 11, wherein the first and second views of the data correspond to a compressed format and an un-compressed format respectively of the data file.

14. The computer program product of claim 13, wherein the data file is stored in an compressed format.

15. The computer program product of claim 14, wherein the first application is a web editor requiring the un-compressed format and the second application is a web server capable of using the compressed format of the data file.

16. The computer program product of claim 11, wherein the first and second views of the data correspond to an encrypted and an unencrypted format respectively of the data file.

17. The computer program product of claim 11, wherein the data file contains text data and wherein each view corresponds to a language such that accessing the file via the first view retrieves the text data in a first language and accessing the file via the second view retrieves the text data in a second language.

18. The computer program product of claim 11, wherein the code means for modifying the data format includes a first filter that is invoked when the file is accessed via the first view.

19. The computer program product of claim 18, wherein the code means for modifying the data format further includes a second filter that is invoked when the file is access via the second view.

20. The computer program product of claim 18, wherein the file is stored in a format compatible with the second application such that accessing the file via the second view requires no format modification.

21. A method of implementing a file system in a data processing system, comprising:
providing first and second views of a file containing data;
enabling first and second applications to access the file via the first and second views respectively; and
modifying the format of the data depending upon which view was used to access the file.

22. The method of claim 21, wherein the first and second views are implemented as first and second directory paths.

23. The method of claim 21, wherein the first and second views of the data correspond to a compressed format and an un-compressed format respectively of the data file.

24. The method of claim 23, wherein the data file is stored in an compressed format.

25. The method of claim 24, wherein the first application is a web editor requiring the un-compressed format and the second application is a web server capable of using the compressed format of the data file.

26. The method of claim 21, wherein the first and second views of the data correspond to an encrypted and an unencrypted format respectively of the data file.

27. The method of claim 21, wherein the data file contains text data and wherein each view corresponds to a language such that accessing the file via the first view retrieves the text data in a first language and accessing the file via the second view retrieves the text data in a second language.

28. The method of claim 21, wherein the code means for modifying the data format includes a first filter that is invoked when the file is accessed via the first view.

29. The method of claim 28, wherein the code means for modifying the data format further includes a second filter that is invoked when the file is access via the second view.

30. The method of claim 28, wherein the file is stored in a format compatible with the second application such that accessing the file via the second view requires no format modification.
